(19) United States
(12) Patent Application Publication
(10) Pub. No.: US 2006/0269685 A1
(43) Pub. Date: Nov. 30, 2006

(54) Method for coating turbine engine components with high velocity particles

(75) Inventors: Derek Raybould, Denville, NJ (US); Margaret M. Floyd, Chandler, AZ (US); Timothy R. Duffy, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/142,055

(22) Filed: May 31, 2005

(51) Int. Cl. C23C 4/00; B05D 1/08; B05D 3/02; B05D 3/00

(52) U.S. Cl. 427/446; 427/314; 427/532

(57) ABSTRACT

A method for coating a surface of a metal component comprises the steps of cold gas-dynamic spraying a powder material on the metal component surface to form a coating, the powder material being sufficiently heated to impact the metal component surface at between about 30% and about 70% of the powder material's melting temperature in kelvins. Another method for coating a surface of a metal component using a powder material comprises the steps of heating the metal component surface to between about 30% and about 70% of the substrate's melting temperature, and then of the powder material's melting temperature in kelvins, and cold gas-dynamic spraying the powder material on the metal component surface to form a coating.

### TECHNICAL FIELD

The present invention relates to methods for coating articles such as gas turbine engine components with metals and alloys having high strength and hardness and, more particularly, to methods for coating at temperatures below the melting points of such metals and alloys.

### BACKGROUND

Cold gas-dynamic spraying is a technique that is sometimes employed to create coatings of various materials onto a substrate. In general, a cold gas-dynamic spraying system uses a pressurized carrier gas to accelerate particles through a supersonic nozzle and toward a targeted surface. The cold gas dynamic spray process is referred to as a “cold gas” process because the particles are mixed and applied at a temperature that is well below their melting point, and the particles are near ambient temperature when they impact with the targeted surface. Converted kinetic energy, rather than a high particle temperature, causes the particles to plastically deform, which in turn causes the particles to form a bond with the targeted surface. Bonding to the component surface occurs as a solid state process with insufficient thermal energy to transition the solid powders to molten droplets. Cold gas-dynamic spraying techniques can therefore produce a wear or corrosion-resistant coating that strengthens and protects the component using a variety of materials that can not be applied using techniques that expose the materials and coatings to high temperatures.

A variety of different systems and implementations can be used to perform a cold gas-dynamic spraying process. For example, U.S. Pat. No. 5,302,414, entitled “Gas-Dynamic Spraying Method for Applying a Coating” describes an apparatus designed to accelerate materials having a particle size of between 5 to about 50 microns, and to mix the particles with a process gas such as air, nitrogen, and helium to provide the particles with a density of mass flow between 0.05 and 17 g/s-cm². Supersonic velocity is imparted to the gas flow, with the jet formed at high density and low temperature using a predetermined profile. The resulting gas and powder mixture is introduced into the supersonic jet to impart sufficient acceleration to ensure a particle velocity ranging between 300 and 1200 m/s. Heat is applied to the carrier gas to between about 300 and about 400° C., but expansion in the nozzle causes the spraying material to cool. The spraying material therefore returns to near ambient temperature by the time it reaches the targeted substrate surface.

When the sprayed particles impinge on the targeted substrate surface, the impact breaks up any oxide films on the particle and substrate surfaces, and bonds to the substrate. Thus, cold gas-dynamic spraying techniques prevent unwanted oxidation of the substrate or powder, and thereby produce a cleaner coating than many other processes. Such techniques also enable the formation of non-equilibrium coatings. More specifically, since the sprayed materials are not heated or otherwise caused to react with each other or with the substrate, coatings can be produced that are not producible using other techniques.

In contrast to cold gas-dynamic spraying, thermal spraying processes include heating methods to bring at least some of the spray material to a melting point, thereby producing a strong and uniform coating. Some thermal spraying processes also utilize a plasma to ionize the sprayed materials or to assist in changing the sprayed materials from solid phase to liquid or gas phase. Melted spraying particles produce liquid splats that land on a targeted substrate surface and bond thereto. Some thermal spraying techniques only supply sufficient heat to melt a fraction of the spraying material particles, and consequently only cause surface melting to occur. One technique, described in U.S. Pat. No. 2,714,563, employs a detonation gun that detonates an explosive gas mixture to launch the spraying material. Even though the spraying materials are only very briefly exposed to the high explosion temperature, melting of the particles still occurs.

Thermal spraying is not a viable method for coating substrates that have relatively low melting temperatures since it may be disadvantageous for the high temperature liquid or particles to react with the substrate, or to disrupt the substrate surface and perhaps lower its strength. Cold gas-dynamic spraying is sometimes a preferred spraying method because it enables the sprayed materials to bond with a substrate at a relatively low temperature. The coating materials that are sprayed using the cold gas-dynamic spraying process typically only incur a net gain of about 100° C. with respect to the ambient temperature. Plastic deformation facilitates metallurgical bonding of sprayed particles to the substrate. Consequently, metallurgical reactions between the sprayed powder and the component surface are minimized. Further, since the sprayed particles are kept well below their melting temperatures, they are not very susceptible to oxidation or other reactions.

Although many materials can be applied to a substrate using cold gas-dynamic spraying techniques, it may be relatively costly to form a coating from some metals and alloys that have particularly high strength or hardness. For example, powders of alloy systems such as NiCrAlY and CoCrAlY require high gas pressures or velocities to impact with a substrate at a sufficient speed to plastically deform and create a dense coating. In addition, very fine powders may be required, such as those less than 25 microns. Creating supersonic gas velocities may require the use of helium gas as a driver, rather than less expensive gases such as air or nitrogen.

Hence, there is a need for a spraying method that is capable of efficiently and cost-effectively producing a wear and oxidation-resistant coating from materials that have high strength or hardness. There is also a need for a spraying method by which such materials can be uniformly and thoroughly applied at temperatures well below their melting points.

### BRIEF SUMMARY

The present invention provides a first method for coating a surface of a metal component. The first method comprises the step of cold gas-dynamic spraying a powder material on the metal component surface to form a coating, the powder material being sufficiently heated to impact the metal component surface at between about 30% and about 70% of the powder material's melting temperature (K).

The present invention also provides a second method for coating a surface of a metal component using a powder material. The second method comprises the steps of heating the metal component surface to between about 30% and about 70% of the substrate's melting temperature, and then powder material's melting temperature (K), and cold gas-dynamic spraying the powder material on the metal component surface to form a coating.

In one embodiment of both the first and second methods, and by way of example only, the powder material and/or the metal component surface is heated to approximately 50% of the powder material's melting temperature (K). Although the powder and substrate may be heated, the temperatures are still sufficiently low to maintain the previously described advantages of cold gas-dynamic spraying. Other independent features and advantages of the preferred methods will become apparent from the following detailed description, taken in conjunction with the accompanying drawing which illustrates, by way of example, the principles of the invention.

### BRIEF DESCRIPTION OF THE DRAWING

FIG. 1 is a schematic view of a cold gas-dynamic spraying apparatus in accordance with an exemplary embodiment of the invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

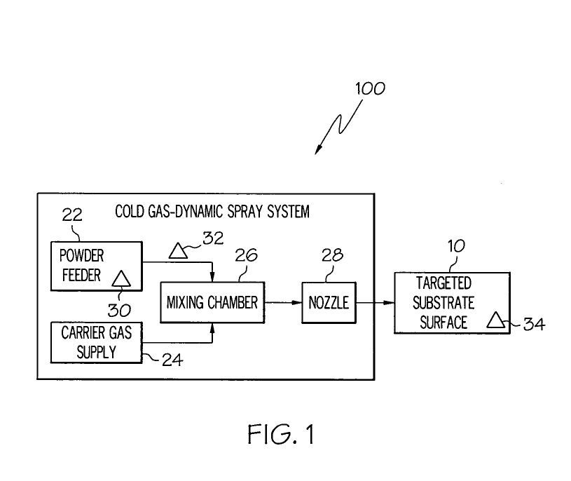

Turning now to FIG. 1, an exemplary cold gas-dynamic spraying (hereinafter “cold spraying”) system 100 is illustrated diagrammatically. The system 100 is illustrated as a general scheme, and additional features and components can be implemented into the system 100 as necessary. The main components of the cold spraying system 100 include a powder feeder 22 for providing powder materials, a carrier gas supply 24 for heating and accelerating powder materials at temperatures of about 300 to 400° C., a mixing chamber 26 and a convergent-divergent nozzle 28. In general, the system 100 transports the metal powder mixtures with a suitable pressurized gas to the mixing chamber 26. The particles are accelerated by the pressurized carrier gas such as air, helium or nitrogen, through the specially designed supersonic nozzle 28 and directed toward a targeted surface 10 on the article being coated.

Cold spraying techniques allow articles to be coated with components that are difficult to apply using other techniques. For example, since elements, compounds, or composite materials are deposited at relatively low temperatures, it is possible to deposit such materials as relatively pure or pre-reacted solids without changing the material to a less stable physical state and thereby cause the material to decompose or react with the substrate that is to be coated.

When optimizing a cold spraying technique for a particular coating material, some considerations include a spraying material's density, elastic modulus, strength, hardness, particle size, and desired impact velocity. Although some characteristics such as density and elastic modulus are not alterable for a given material, a cold spraying technique may be adapted to correspond to the spraying material's characteristics and thereby produce a strong and durable coating.

One way to adapt a cold spraying technique in consideration of a spraying material's strength or hardness is to modify the material's temperature. For example, increasing a particle's temperature softens the particle so it will readily deform upon impact with a substrate surface. Hence, softening a particle by raising its temperature improves both particle to substrate bonding and particle to particle bonding at lower impact velocities than those used without particle softening. Softening the material also enables the powder particle size to be increased from the <25 microns required for difficult powders. Exemplary powders have particle sizes ranging between about 5 to about 120 microns. The increased allowable particle size further enables the use of materials that currently require thermal spraying for effective coating, which is more costly to perform than the methods of the present invention. Thus, the current method provides the advantages of reduced cost and a wider variety of available powder materials.

Careful particle temperature control allows for significant softening without unnecessarily using excess or expensive propellant gases that would be necessary to increase the particle velocity and accomplish equivalent bonding. Further, carefully selecting a particle temperature that does not result in particle oxidation, distortion, or undesirable reactions or phase transformations maintains the advantages provided by conventional cold spraying processes. Heating the spraying material particles so that they impact with the substrate at between about 30% and about 70% of the spraying material melting temperature (K) significantly softens the particles and therefore improves bonding at lower impact velocities. In an exemplary embodiment the spraying material particles are heated so that they impact with the substrate at between about 40% and 60% of the material melting temperature (K), and most preferably at about 50% of the spraying material melting temperature (K).

Returning to FIG. 1, a heat symbol Δ 30 indicates that heat is applied to spray material in a powder feeder 22 to soften the particles before they are mixed with carrier gas in the mixing chamber 26 and launched from the nozzle 28. Heat can be applied to the particles in this static manner using a variety of exemplary devices including an electrical resistance heating apparatus, an induction heating apparatus, and a gas-burning apparatus.

In contrast to the static application of heat to spray material in a powder feeder 22, heat symbol Δ 32 indicates that heat can be dynamically applied to the spray material as the particles are transferred from the powder feeder 22 to the mixing chamber 26. An exemplary method for softening the spray material particles in this respect includes spiraling a particle transferring tube through a heat source such as a resistance heating apparatus, an induction heating apparatus, and a gas-burning apparatus.

As mentioned previously, the spraying materials are heated so that they impact with the substrate at predetermined temperatures. Some cooling occurs as the sprayed materials leave the spray nozzle and travel toward the targeted substrate surface. Thus, to obtain the desired impact temperatures, the spray materials are heated to higher than impact temperatures before they are sprayed from the spray nozzle. For example, if the spraying materials have a 30 to 70% melting temperature (K) range that is between 200 and 400° C., it will be necessary to heat the spraying materials higher than 200 to 400° C. When spraying material temperatures are between 200 and 400° C. just before being sprayed from the spray nozzle, the spraying materials reach the targeted substrate surface at temperatures ranging between room temperature and 100° C. For low melting point spraying materials, even a small increase in particle temperatures prior to impact with the substrate is beneficial.

For most materials, the average temperature for the cold sprayed coating material, upon impact with the targeted substrate, is less than 100° C. For materials such as aluminum this is just less than 40% of the melting temperature (K). However, for other materials such as nickel, iron, or titanium, a temperature of 100° C. does not significantly improve bonding.

Optimal heating temperatures are decided by determining a range at which effective softening occurs, while undesirable reactions or phase changes are prevented. Ideally, the powder or substrate is heated to temperatures that result in significant softening, for instance to around 225° C. for aluminum. However, other factors such as oxidation of the powder or substrate, phase changes, and potential chemical reactions must also be considered. For example, oxidation is not problematic for aluminum, although for some aluminum alloys undesirable phase changes may occur above about 150° C. Potential phase changes may not be important considerations if the cold spraying process is to be followed by a heat treatment, but it is important to control the preheat temperatures to avoid oxidation or chemical reactions for materials like copper that oxidize at relatively low temperatures.

Predicting temperatures at which the spraying materials will undergo beneficial softening is complex for many different metal alloys. It may be important to maintain particular crystal structures, i.e., fcc, bcc, hcp, and to ensure that heating does not adversely affect properties pertaining to corrosion, toughness, strength, elevated temperature strength, etc. Despite the various differences between alloys and other materials having particular crystal structures, temperatures upon impact that are between about 40% and about 60% of the melting temperature (K) effectively prevent melting of the powder during coating while facilitating effective coating using relatively low gas velocities. For powder mixtures, the temperature should be between about 40% and about 60% of the melting temperature for the component having the lowest melting temperature. For example, for a mixture of an aluminum—12% silicon alloy plus titanium carbide, the mixture should be heated to about 50% of the melting temperature (K) for the Al 12% Si, which is about 150° C.; the temperature is much lower than about 1430° C. which is about 50% of the melting temperature (K) for the titanium carbide.

Another exemplary method for softening spray material particles and improving particle to substrate and particle to particle bonding is to heat the substrate surface. In FIG. 1, heat symbol Δ 34 indicates that heat is applied at least to the targeted substrate surface 10 on which the coating material particles are impinging. To obtain optimal substrate and particle softening, the targeted substrate surface is first heated to between about 30% and about 70% of the substrate melting temperature (K), and the temperature is then adjusted to between about 30% and about 70% of the spraying material melting temperature (K). If the substrate has a large thermal mass and cannot be quickly heated or cooled, then the substrate is heated to about 50% of the average of the substrate melting temperature and the spraying material melting temperature (K) unless the average is more than 70% of the spraying material or substrate melting temperature (K). In this or other cases wherein it is not practical to heat at both temperatures, then simply heating the substrate to between about 30% and about 70% of the lower melting temperature (K) is acceptable. In an exemplary embodiment the targeted substrate surface is heated to between about 40% and about 60% of both the substrate and the spraying material melting temperatures (K), and most preferably to about 50% of their melting temperatures (K). Softening both the substrate and the spraying material in this manner significantly initially softens the substrate, and subsequently softens the sprayed coating and therefore improves bonding at lower impact velocities. In addition to softening the impacting particles, heating at least the targeted substrate surface 10 will soften the substrate and cause at least the initially-sprayed powder particles to be imbedded therein.

Even if the particles are not pre-heated using the previously-described methods, heating the targeted substrate surface 10 causes the initially-sprayed particles to quickly attain the substrate temperature and consequently soften so that subsequent layers of sprayed particles will bond to the initially-sprayed particles. Thus, a thick and dense coating is able to be built up while reducing the spraying material's required impact velocity.

Many heating methods can be tailored to heat a variety of different targeted substrate surfaces. For example, a suitable heating method is selected by considering the substrate shape and physical characteristics, and whether it is more beneficial to heat the entire substrate or only local substrate areas. The present methods are particularly useful for metal substrates since they will be heated to temperature ranges based around 0.5 Tₘ of hard or high strength metallic spraying materials. Some exemplary heating devices include a gas burning apparatus, an electric heater, a heat lamp, and an induction heating apparatus.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for coating a surface of a metal component, the method comprising the step of:
cold gas-dynamic spraying a powder material on the metal component surface to form a coating, the powder material being sufficiently heated to impact the metal component surface at between about 30% and about 70% of the powder material's melting temperature in kelvins.

2. The method according to claim 1, wherein the powder is sufficiently heated to impact the metal component surface at between about 40% and about 60% of the material's melting temperature in kelvins.

3. The method according to claim 1, wherein the powder is sufficiently heated to impact the metal component surface at about 50% of the material's melting temperature in kelvins.

4. The method according to claim 1, wherein the powder material has a particle size from 5 to 120 microns.

5. The method according to claim 1, wherein the cold gas-dynamic spraying step is performed using a system comprising a powder feeder and a mixing chamber that is in communication with the powder feeder and adapted to mix the powder material with a carrier gas, and
the powder material is heated in the powder feeder before being mixed with the carrier gas.

6. The method according to claim 5, wherein the powder material is heated using a device selected from the group consisting of an electrical resistance heating apparatus, an induction heating apparatus, and a gas-burning apparatus.

7. The method according to claim 1, wherein the cold gas-dynamic spraying step is performed using a system comprising a powder feeder, a mixing chamber adapted to mix the powder material with a carrier gas, and a tube adapted to feed the powder material to the mixing chamber, and
the powder material is heated in the tube while being transferred to the mixing chamber.

8. The method according to claim 7, wherein the powder material is heated using a device selected from the group consisting of an electrical resistance heating apparatus, an induction heating apparatus, and a gas-burning apparatus.

9. The method according to claim 1, further comprising the step of:
heating the metal component surface before cold gas-dynamic spraying the heated powder material on the metal component surface.

10. A method for coating a surface of a metal component using a powder material, the method comprising the steps of:
heating the metal component surface to between about 30% and about 70% of the powder material's melting temperature in kelvins; and
cold gas-dynamic spraying the powder material on the metal component surface to form a coating.

11. The method according to claim 10, wherein prior to heating the metal component surface to between about 30% and about 70% of the powder material's melting temperature in kelvins, the method further comprises the step of:
heating the metal component surface to between about 30% and about 70% of the metal component's melting temperature in kelvins,

12. The method according to claim 10, wherein the metal component surface is heated to between about 40% and about 60% of the powder material's melting temperature in kelvins.

13. The method according to claim 10, wherein the metal component surface is heated to about 50% of the powder material's melting temperature in kelvins.

14. The method according to claim 10, wherein the metal component surface is heated using a device selected from the group consisting of a gas burning apparatus, an electric heater, a heat lamp, and an induction heating apparatus.

15. The method according to claim 10, further comprising the step of:
heating the powder material before cold gas-dynamic spraying the powder material on the metal component surface.

16. The method according to claim 15, wherein the cold gas-dynamic spraying step is performed using a system comprising a powder feeder and a mixing chamber that is in communication with the powder feeder and adapted to mix the powder material with a carrier gas, and the powder material is heated in the powder feeder before mixing the powder material with the carrier gas.

17. The method according to claim 16, wherein the powder material is heated using a device selected from the group consisting of an electrical resistance heating apparatus, an induction heating apparatus, and a gas-burning apparatus.

18. The method according to claim 15, wherein the cold gas-dynamic spraying step is performed using a system comprising a powder feeder, a mixing chamber adapted to mix the powder material with a carrier gas, and a tube adapted to feed the powder material to the mixing chamber, and the powder material is heated in the tube while transferring the powder material to the mixing chamber.

19. The method according to claim 18, wherein the powder material is heated using a device selected from the group consisting of an electrical resistance heating apparatus, an induction heating apparatus, and a gas-burning apparatus.

20. The method according to claim 10, wherein the powder material has a particle size from 5 to 120 microns.
